(19) United States
(12) Patent Application Publication
(10) Pub. No.: US 2022/0094906 A1
(43) Pub. Date: Mar. 24, 2022

(54) SEMICONDUCTOR DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Sohichiroh HOSODA, Kawasaki Kanagawa (JP)

(21) Appl. No.: 17/200,405

(22) Filed: Mar. 12, 2021

(30) Foreign Application Priority Data
Sep. 18, 2020 (JP) 2020-157796

(51) Int. Cl. H04N 17/00; H04N 7/18; G07C 5/08

(52) U.S. Cl. CPC H04N 17/002; G07C 5/0816; G07C 5/0808; H04N 7/18

(57) ABSTRACT

A semiconductor device of an embodiment includes two hardware accelerators, and a DCLS (dual-core lock-step) controller. The DCLS controller operates the hardware accelerators to respectively perform a first function and a second function in each execution cycle among multiple execution cycles, and determines a timing of an execution cycle at which the two hardware accelerators are operated with a dual-core lock-step configuration among the execution cycles included in a fault detection time interval (FDTI).

### CROSS-REFERENCE TO RELATED APPLICATIONS

This application is based upon and claims the benefit of priority from the prior Japanese Patent Application No. 2020-157796 filed in Japan on Sep. 18, 2020; the entire contents of which are incorporated herein by reference.

### FIELD

An embodiment described herein relates generally to a semiconductor device.

### BACKGROUND

In recent years, functional safety has been attracting attention, as securing product safety. For example, International Organization for Standardization (ISO) issues ISO 26262 defining functional safety about automobiles.

ISO 26262 defines a fault detection time interval (hereinafter abbreviated as FDTI), as a predetermined time period from occurrence of a fault in a device to detection of the fault. The FDTI is a requirement specification for semiconductor devices mounted on automobiles. In case a fault occurs in a semiconductor device itself, the semiconductor device detects the fault in an FDTI, and notifies an ECU (electronic control unit; hereinafter, referred to as the ECU) of the fault. Accordingly, the ECU can take appropriate measures for causing an automobile to avoid danger and come into a safe state.

Methods of testing a semiconductor device itself may include, for example, the BIST (built-in self test). Unfortunately, even if a semiconductor device has a BIST function, there is a possibility that as the circuit scale of the semiconductor device is large, a self-diagnosis function by the BIST is not completed in an FDTI.

For fault diagnosis, a dual-core lock-step scheme (hereinafter, abbreviated as DCLS) can be adopted for the semiconductor device. However, in a case of the dual-core lock-step scheme, there is a problem in that if a DCLS is simply achieved by providing two circuit blocks for each function, the circuit scale is doubled.

### BRIEF DESCRIPTION OF THE DRAWINGS

FIG. 1 is a block diagram of a semiconductor device of an embodiment;

FIG. 2 shows a time chart for illustrating a fault detection time interval (FDTI) in the embodiment;

FIG. 3 is a block diagram showing a configuration of an ECC_SRAM wrapper module in the embodiment; and

FIG. 4 is a diagram showing a time schedule of processes executed in two hardware accelerators in the embodiment.

### DETAILED DESCRIPTION

A semiconductor device of an embodiment includes: a first hardware accelerator and a second hardware accelerator; and a controller configured to operate the first and second hardware accelerators so as to perform a first function and a second function of the respective hardware accelerators in each execution cycle among a plurality of execution cycles, and determine a timing of an execution cycle in which the first and second hardware accelerators are operated with a dual-core lock-step configuration among the execution cycles included in a predetermined period.

An embodiment is hereinafter described with reference to the drawings.

### First Embodiment

### (Configuration)

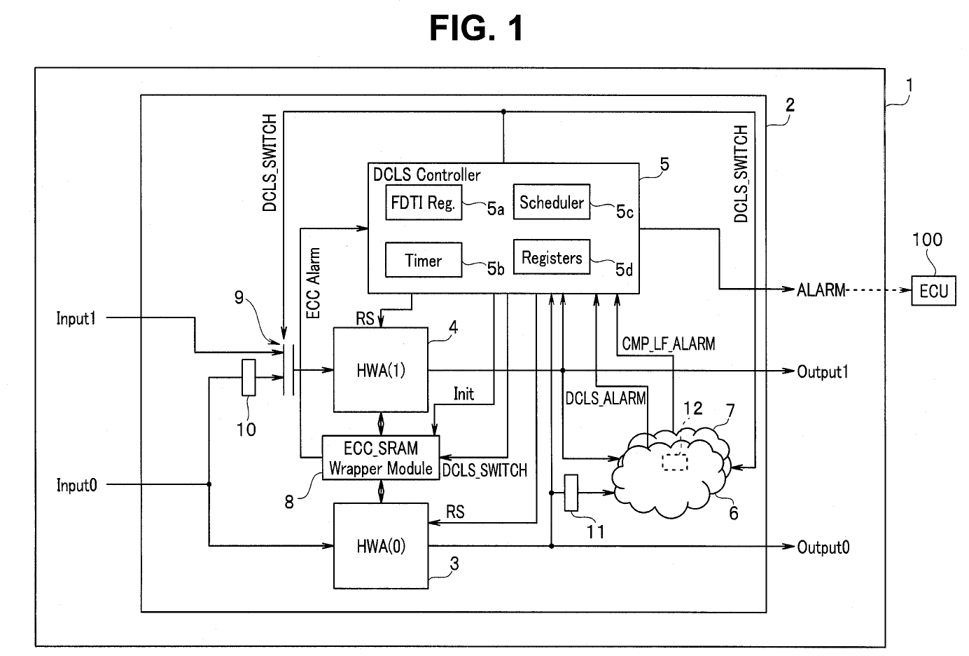

FIG. 1 is a block diagram of a semiconductor device of the present embodiment. The semiconductor device 1 is a semiconductor device to be mounted on a vehicle, and performs image processing. The semiconductor device 1 includes a hardware acceleration unit 2 that includes a plurality of hardware accelerators (hereinafter referred to as HWAs). Image data from an image sensor or an image signal processor (hereinafter referred to as an ISP), not shown, is input into the hardware acceleration unit 2.

The semiconductor device 1 executes predetermined multiple functions. The semiconductor device 1 also has a function of notifying fault occurrence to an ECU 100 that is an electronic control device mounted on an automobile in case a fault is detected in the semiconductor device 1.

The hardware acceleration unit 2 includes two HWAs 3 and 4, a DCLS (dual-core lock-step) controller 5, two comparators 6 and 7, an ECC_SRAM wrapper module 8, a selector 9, and two buffers 10 and 11. FIG. 1 shows a case where the hardware acceleration unit 2 includes the two HWAs 3 and 4.

Each of the HWAs 3 and 4 is a functional block. Two input data items Input 0 and Input 1 input into the respective two HWAs 3 and 4 may be the same image data item or image data items different from each other. The HWAs 3 and 4 each perform various processes of recognition of objects, such as a person and a traffic light, for the image data items from the image sensor or the ISP. Each of the HWAs 3 and 4 can execute various types of recognition processes. The two HWAs 3 and 4 can execute the same recognition process, and can execute recognition processes different from each other.

Each of the HWAs 3 and 4 executes functional processes, such as of recognition of a person and recognition of a traffic light, for frame images for every predetermined execution cycle tp. Note that the execution cycle tp is sometimes a non-fixed value. Functions of the HWAs 3 and 4 are performed by processes on a first and second frame images input into the respective HWAs 3 and 4, for every execution cycle tp.

For example, in a case where each of the HWAs 3 and 4 performs a recognition process based on a neural network for image data items, each of the HWAs 3 and 4 changes various parameters set in the neural network, thereby allowing various recognition processes to be executed.

As describe later, each of the HWAs 3 and 4 is a functional block. The two HWAs 3 and 4 can execute functions different from each other, and execute the same function according to a DCLS scheme by the DCLS controller 5.

Note that here, each functional block of the semiconductor device 1 is an HWA, but may be a processor including a central processing unit (CPU) instead.

The DCLS controller 5 controls the operations of the two HWAs 3 and 4 such that each of the HWAs 3 and 4 executes a predetermined process on frame images at a predetermined execution cycle tp. Images in units of frames, that is, frame images, from the ISP are input into each of the HWAs 3 and 4. Each of the HWAs 3 and 4 executes the predetermined process on the frame images. The processes executed for each frame image in the HWAs 3 and 4 are set by a reset signal RS from the DCLS controller 5. An output Output 0 of the HWA 3 and an output Output 1 of the HWA 4 are supplied to the DCLS controller 5.

After the process is finished for one frame image, the DCLS controller 5 transmits the reset signal RS to the HWAs 3 and 4 in a vertical blanking interval. Each of the HWAs 3 and 4 is reset by the reset signal RS, and receives designation of a process to be executed for the next frame image. The reset signal RS includes setting parameter data that designates processing details to be executed for the next frame image.

The DCLS controller 5 includes an FDTI register 5a, a timer 5b, a scheduler 5c, and registers 5d. The registers 5d can store various data items. For example, data, such as various alarm signals, and estimated maximum time periods of the HWAs 3 and 4, can be stored in the registers 5d.

The FDTI register 5a is a register that stores FDTI values. The FDTI is a freely set time interval, and is preliminarily set from the ECU 100 or the like and stored. The FDTI is a predetermined set period from occurrence of a fault in the semiconductor device 1 to detection of the fault.

The FDTI value stored in the FDTI register 5a is set in the timer 5b. The timer 5b is a remaining time period output circuit that includes a counter that counts the remaining time period tr until a lapse of the set FDTI. Accordingly, the timer 5b starts time measurement at a predetermined timing, subtracts, from the FDTI, an elapsed time period from the start timing of the time measurement, and outputs the obtained time period as a remaining time period tr in the FDTI.

Note that the timer 5b may be replaced with a remaining time period output circuit that includes a register for storing the FDTI value, and a free running counter. The free running counter is reset at a time measurement start timing. In this case, a value obtained by subtracting the count value of the free running counter from the value of the register for storing the FDTI value is output.

When the elapsed time period tc coincides with the FDTI, the timer 5b resets the counter, and counts the remaining time period tr until a lapse of the FDTI again. In other words, the timer 5b repeats the time measurement of the remaining time period tr at every lapse of the FDTI.

To detect occurrence of a fault of the semiconductor device 1 in the FDTI, the scheduler 5c determines the timing at which the HWAs 3 and 4 are operated with the DCLS configuration on the basis of the remaining time period tr indicated by the timer 5b, and controls the HWAs 3 and 4 to be operated with the DCLS configuration.

In other words, the DCLS controller 5 operates the HWAs 3 and 4 at multiple execution cycles tp so as to perform the respective functions in the execution cycles tp, and determines the timing of the execution cycles at which the HWAs 3 and 4 are operated with the dual-core lock-step configuration in the multiple execution cycles included in the FDTI, which is the predetermined period. In particular, the DCLS controller 5 determines the timing of the execution cycle tp at which the HWAs 3 and 4 are operated with the dual-core lock-step configuration, on the basis of the FDTI stored in the FDTI register 5a and of the remaining time period tr output from the timer 5b.

Note that here, a fault of the semiconductor device 1 means a permanent fault, such as breaking of wire, and does not include any transit fault due to noise or the like. The transit fault is addressed by AoU (Assumption of Use), such as monitoring of processing results of multiple frames, in the ECU 100 or the like.

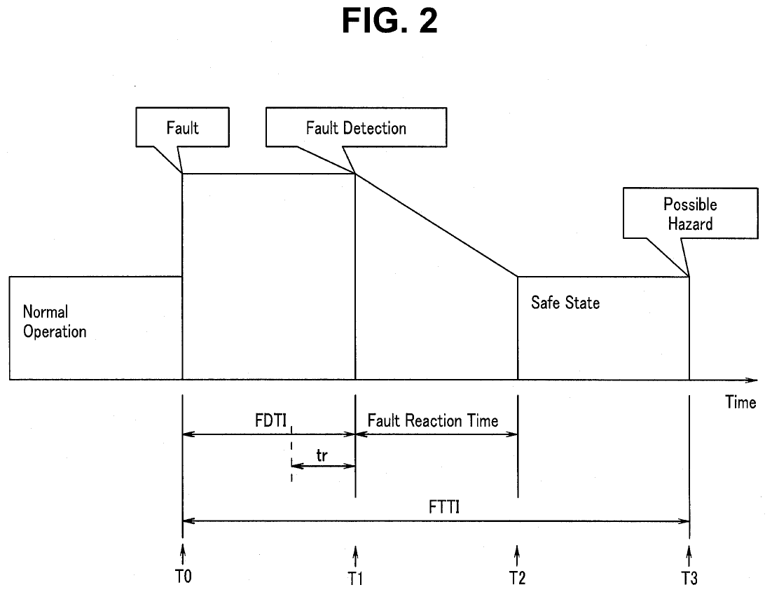

FIG. 2 is a time chart for illustrating the FDTI. For example, in case a fault occurs in the semiconductor device 1, the fault should be detected in the FDTI after time T0 when the fault occurs.

FIG. 2 shows that a fault occurs at time T0 while the semiconductor device 1 is in a normal operation. At time t1, the fault is detected. When the fault of the semiconductor device 1 is detected, the semiconductor device 1 transmits an alarm signal ALARM to the ECU 100 that is an upper device at time t1, thereby notifying the ECU 100 of occurrence of the fault.

A period from the occurrence of the fault (T0) of the semiconductor device 1 to occurrence of a possible hazard (T3) is a fault tolerant time interval (hereinafter referred to as an FTTI). Consequently, the fault is detected in the FDTI after occurrence of the fault of the semiconductor device 1, and various measures are taken in a fault reaction time period (hereinafter referred to as FRT) that is a period from time T1 to T2, thereby allowing the automobile to transition to a safe state in the FTTI.

Therefore, when the ECU 100 receives the alarm signal ALARM from the semiconductor device 1 at time t1, the ECU 100 takes predetermined measures in the fault reaction time period FRT, thereby allowing the automobile to come into the safe state in an automatic drive system, for example.

The scheduler 5c is a circuit that determines a timing at which the HWAs 3 and 4 are operated with the DCLS configuration. The scheduler 5c determines the timing at which the HWAs 3 and 4 are operated with the DCLS configuration, on the basis of the remaining time period tr indicated by the timer 5b and of the processing time period (the estimated maximum time period described later) of each of the HWAs 3 and 4. The method of determining the timing is described later.

When the DCLS controller 5 operates the HWAs 3 and 4 with the DCLS configuration, the DCLS controller 5 outputs a switching signal DCLS_SWITCH. The switching signal DCLS_SWITCH is supplied to the comparators 6 and 7, the ECC_SRAM wrapper module 8, and the selector 9.

The DCLS controller 5 can output an initialization signal Init for causing the ECC_SRAM wrapper module 8 to perform initialization. The initialization signal Init is output to the ECC_SRAM wrapper module 8 at the beginning of each cycle.

The comparator 6 is a circuit that compares the two outputs of the two HWAs 3 and 4 with each other. The comparator 7 is also a circuit that compares the two outputs of the two HWAs 3 and 4 with each other. The comparators 6 and 7 include comparison circuits. The two outputs of the two HWAs 3 and 4 are input into each of the comparators 6 and 7. While the comparators 6 and 7 receive the switching signal DCLS_SWITCH, these comparators each compare the two outputs of the two HWAs 3 and 4. When the two outputs of the two HWAs 3 and 4 do not coincide with each other, the comparators 6 and 7 output an alarm signal DCLS_ALARM to the DCLS controller 5. Note that when the comparators 6 and 7 each receive no switching signal DCLS_SWITCH, these comparators each output the same value, for example, “0”.

The alarm signal DCLS_ALARM indicates a possibility that any of the HWAs 3 and 4 has a fault.

The outputs of the comparators 6 and 7 are input into a comparator 12 (indicated by broken lines). The comparator 12 is a comparison circuit that compares the two output signals of the two comparators 6 and 7 with each other. The comparator 12 is an exclusive OR (XOR) circuit, for example. The comparator 12 compares the two outputs of the two comparators 6 and 7 with each other. When the two outputs of the two comparators 6 and 7 do not coincide with each other, the comparator 12 outputs an alarm signal CMP_LF_ALARM to the DCLS controller 5.

The alarm signal CMP_LF_ALARM indicates a possibility that the comparator 6 or 7 has a fault.

Here, only when the switching signal DCLS_SWITCH is received, the comparators 6, 7 and 12 perform comparison, and output, to the DCLS controller 5, the alarm signal DCLS_ALARM as a comparison result signal, and the alarm signal CMP_LF_ALARM from the comparator 12. Alternatively, the comparators 6, 7 and 12 may always perform comparison, and output the comparison result. In this case, in the DCLS controller 5, a mask process of whether the comparison results from the comparators 6 and 7 are received or not is performed.

The DCLS controller 5 can store data items on the alarm signal DCLS_ALARM and the alarm signal CMP_LF_ALARM, in predetermined two registers among the internal registers 5d.

When the DCLS controller 5 receives any of the alarm signal DCLS_ALARM and the alarm signal CMP_LF_ALARM, the DCLS controller 5 stores the signal in a predetermined two registers among the registers 5d, and outputs the alarm signal ALARM to the ECU 100.

In other words, during the HWAs 3 and 4 operating with the dual-core lock-step configuration, if the output of the HWA 3 and the output of the HWA 4 do not coincide with each other as the result of comparison by the comparators 6 and 7, the DCLS controller 5 outputs the alarm signal ALARM. In particular, only during the HWAs 3 and 4 operating with the dual-core lock-step configuration, the DCLS controller 5 outputs the alarm signal ALARM on the basis of the result of comparison by the comparators 6 and 7.

Furthermore, the DCLS controller 5 also outputs the alarm signal ALARM even if the comparison result of the comparator 6 and the comparison result of the comparator 7 do not coincide with each other.

When the ECU 100 receives the alarm signal ALARM, the ECU 100 executes a predetermined process for causing the automobile to transition to the safe state in the FTTI. The ECU 100 can read the data items on the alarm signal DCLS_ALARM and the alarm signal CMP_LF_ALARM from the registers of the DCLS controller 5.

Consequently, when the ECU 100 receives the alarm signal ALARM, the ECU 100 requests data in the registers 5d from the DCLS controller 5. The ECU 100 can determine which one of the alarm signal DCLS_ALARM and the alarm signal CMP_LF_ALARM the occurrence of the alarm signal ALARM is based on, on the basis of the received data in the registers 5d.

The DCLS controller 5 can output the initialization signal Init for initializing data in an SRAM in the ECC_SRAM wrapper module 8.

The ECC_SRAM wrapper module 8 is a memory used when data used in the HWAs 3 and 4 is written and read, and can detect an error in cases of data is written and read.

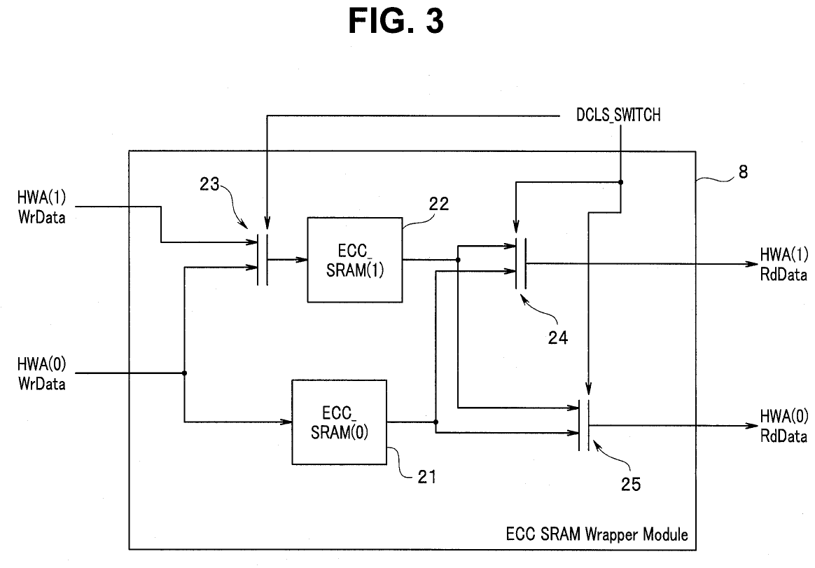

FIG. 3 is a block diagram showing the configuration of the ECC_SRAM wrapper module 8. The ECC_SRAM wrapper module 8 includes two ECC_SRAMs 21 and 22, and three selectors 23, 24 and 25.

The ECC_SRAMs 21 and 22 are SRAMs having an error correction function. When data items to be processed by the HWAs 3 and 4 are written, the ECC_SRAMs 21 and 22 add error correction codes and store the data items. When data items are read by the HWAs 3 and 4, the respective ECC_SRAMs 21 and 22 detect and correct an error using an error correction code.

In other words, the ECC_SRAM wrapper module 8 includes the ECC_SRAMs 21 and 22 that the respective HWAs 3 and 4 use to write and read data. The ECC_SRAMs 21 and 22 are volatile memories that each have a function of correcting an error of data.

If the error cannot be corrected in the ECC_SRAMs 21 and 22, the ECC_SRAM wrapper module 8 outputs an alarm signal ECC Alarm to the DCLS controller 5 (FIG. 1).

When the ECC_SRAM wrapper module 8 receives the initialization signal Init for initializing the ECC_SRAMs 21 and 22, the ECC_SRAM wrapper module 8 initializes the ECC_SRAMs 21 and 22 (FIG. 1). When the initialization signal Init is received, the data items in the ECC_SRAMs 21 and 22 become the initial values.

The selector 23 receives data items written in the HWAs 3 and 4, selects the data item from the HWA 3 or the HWA 4 on the basis of presence or absence of the switching signal DCLS_SWITCH, and outputs the selected data items to the ECC_SRAM 22. While the switching signal DCLS_SWITCH is not received, the selector 23 selects the data item from the HWA 4, and supplies the item to the ECC_SRAM 22. While the selector 23 receives the switching signal DCLS_SWITCH, the selector 23 selects the data item from the HWA 3, and supplies the item to the ECC_SRAM 22.

The ECC_SRAM 22 stores the data item from the HWA 3 or 4 via the selector 23. The data item to which the error correction code is added is stored in the ECC_SRAM 22.

The ECC_SRAM 21 stores the data item from the HWA 3. The data item to which the error correction code is added is also stored in the ECC_SRAM 21.

The selectors 24 and 25 receive two data items from the ECC_SRAMs 21 and 22, select one of the two data items from the ECC_SRAMs 21 and 22 based on the switching signal DCLS_SWITCH, and output the selected data item.

While the selectors 23, 24 and 25 receive no switching signal DCLS_SWITCH, the selectors are controlled to write the data item from the HWA 3 into the ECC_SRAM 21, and output the data item in the ECC_SRAM 21 to the HWA 3. Likewise, while the selectors 23, 24 and 25 receive no switching signal DCLS_SWITCH, the selectors are controlled to write the data item from the HWA 4 into the ECC_SRAM 22, and output the data item in the ECC_SRAM 22 to the HWA 4.

While the selectors 23, 24 and 25 receive the switching signal DCLS_SWITCH, the selectors are controlled to write the data item from the HWA 3 into the ECC_SRAMs 21 and 22, and output the data item in the ECC_SRAMs 21 and 22 to the respective HWAs 4 and 3. In other words, the same data item is input into the ECC_SRAMs 21 and 22 at the timing of execution cycle for operating the HWAs 3 and 4 with the dual-core lock-step configuration.

Returning to FIG. 1, the selector 9 is a circuit that switches the input into the HWA 4 from an input signal Input1 to an input signal Input0 according to the switching signal DCLS_SWITCH from the DCLS controller 5. While the selector 9 receives the switching signal DCLS_SWITCH, the selector 9 supplies the input signal Input0 to the HWA 4.

In other words, the semiconductor device 1 includes the selector (9) that selects any of the two inputs input into the HWAs 3 and 4. The DCLS controller 5 controls the selector 9 so as to input the same input into the HWAs 3 and 4 at the timing of execution cycle for operating the HWAs 3 and 4 with the dual-core lock-step configuration.

The buffer 10 is provided on an input side of the selector 9 so as to delay the input signal Input0. The buffer 10 is a circuit that temporarily stores the input signal Input0, and delays, by a predetermined time period, the time period until the input signal Input0 is output to the selector 9.

The buffer 11 is provided between the HWA 3 and the comparator 6. The buffer 11 is a circuit that delays, by a predetermined time period, the time period until the output of the HWA 3 is output to the comparator 6.

The two buffers 10 and 11 are circuits that temporarily store the input signals, and delay the time period until outputting the signals as output signals, in order to determine the functional safety more accurately.

Accordingly, the buffer 10 delays Input0 by a predetermined time period, and supplies Input0 to the HWA 4. The buffer 11 delays the output of the HWA 3 by a predetermined time period, and supplies the output to the comparators 6 and 7.

Note that the buffers 10 and 11 are provided so as to determine the functional safety highly accurately, but are not necessarily provided.

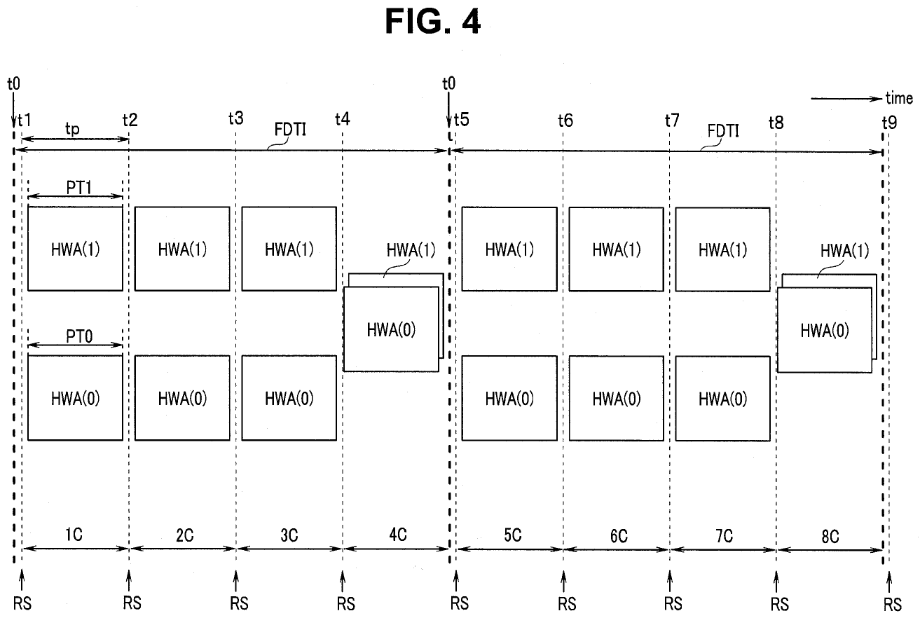

FIG. 4 is a diagram showing a time schedule of processes executed in the HWAs 3 and 4. As described above, each of the HWAs 3 and 4 executes a predetermined process (recognition of a person and recognition of a traffic light) for the frame images for every predetermined execution cycle tp.

More specifically, the DCLS controller 5 outputs the reset signal RS to the HWAs 3 and 4 at the beginning of each execution cycle tp (for example, the vertical blanking interval). Frame images are input into each of the HWAs 3 and 4 such that processes of predetermined functions are performed for every execution cycle tp. The HWAs 3 and 4 execute predetermined processes on the frame images, and output recognition results as outputs Output0 and Output1. For example, the HWA 3 executes a person recognizing process, and the HWA 4 executes a traffic light recognizing process. The HWAs 3 and 4 output the respective recognition results for every execution cycle tp.

In case a fault occurs in the semiconductor device 1, the DCLS controller 5 is required to detect the occurrence of the fault in the FDTI and notify the ECU 100 of an alarm. Accordingly, in case the fault occurs during the HWAs 3 and 4 in operation, the DCLS controller 5 operates the HWAs 3 and 4 with the DCLS configuration such that the occurrence of the fault can be detected in the FDTI, and the ECU 100 can be notified of the alarm ALARM.

More specifically, the scheduler 5c of the DCLS controller 5 determines the timing (hereinafter also referred to as DCLS configuration execution timing) at which the HWAs 3 and 4 are executed with the DCLS configuration, on the basis of the remaining time period tr of the timer 5b. In other words, the DCLS controller 5 determines the DCLS configuration execution timing so as to determine presence or absence of a fault in the HWAs 3 and 4 in the FDTI.

In a case of FIG. 4, the execution cycle tp starts at time t1, t2, . . . , the recognition process is executed in each execution cycle tp, and recognition results are output as outputs Output0 and Output1 from the respective HWAs 3 and 4.

In FIG. 4, the timer 5b starts time measurement of the remaining time period tr, at time t0 close to time t1 in the FDTI. Subsequently, when the FDTI elapses, the timer 5b restarts time measurement of the remaining time period tr. Thus, the timer 5b outputs the remaining time period tr for every FDTI.

At the start time t1 in the first execution cycle after start of time measurement of the timer 5b, the DCLS controller 5 determines which ordinal number of execution cycle in which to operate the HWAs 3 and 4 with the DCLS configuration in the remaining time period tr, and outputs the reset signal RS.

In the case of FIG. 4, in consideration of processing time periods PT0 and PT1 of the respective HWAs 3 and 4 in each execution cycle, the timing at which the HWAs 3 and 4 are operated with the DCLS configuration is determined to be executable at a fourth execution cycle 4C close to the end of the FDTI. The processing time periods PT0 and PT1 are different from each other according to functions executed in the HWAs 3 and 4. Accordingly, based on the longest estimated maximum time period, the execution cycle at which the HWAs 3 and 4 are operated with the DCLS configuration is determined. The estimated maximum time period may be preset in a predetermined register among the registers 5d of the DCLS controller 5, or may be a value selected from among previous maximum processing time periods of the HWAs 3 and 4 actually measured by the DCLS controller 5 or estimated and set in the predetermined register among the registers 5d.

Also at time t2, the DCLS controller 5 determines which ordinal number of execution cycle in which to operate the HWAs 3 and 4 with the DCLS configuration in the remaining time period tr indicated by the timer 5b, and outputs the reset signal RS. As a result, the HWAs 3 and 4 execute predetermined processes on the basis of the reset signal RS. Also at time t2, it is determined to be executable at the fourth execution cycle 4C close to the end of the FDTI.

Likewise, also at time t3, the DCLS controller 5 determines which ordinal number of execution cycle in which to operate the HWAs 3 and 4 with the DCLS configuration in the remaining time period tr, and outputs the reset signal RS. As a result, the HWAs 3 and 4 execute predetermined processes on the basis of the reset signal RS. Also at time t3, it is determined to be executable at the fourth execution cycle 4C close to the end of the FDTI.

Then at time t4, the DCLS controller 5 determines which ordinal number of execution cycle in which to operate the HWAs 3 and 4 with the DCLS configuration in the remaining time period tr; it is determined that the HWAs 3 and 4 are operated with the DCLS configuration in the remaining time period tr. Here, it is determined that two or more estimated maximum time periods cannot be included in the remaining time period tr, and the HWAs 3 and 4 are operated with the DCLS configuration in the fourth execution cycle 4C.

Consequently, the DCLS controller 5 outputs only the reset signal RS to the HWAs 3 and 4 at time t1, t2 and t3. At time t4 that is the timing of starting the fourth execution cycle 4C, the reset signal RS and the switching signal DCLS_SWITCH are output to the HWAs 3 and 4 so as to operate the HWAs 3 and 4 with the DCLS configuration.

The timer 5b is reset every time the remaining time period tr becomes zero. When the timer 5b is reset, the timer 5b restarts the output of the remaining time period tr of the FDTI.

As shown in FIG. 4, also at and after time t5 subsequent to time t4, determination similar to the process at and after time t1 described above is performed.

Note that here, the DCLS controller 5 determines that the HWAs 3 and 4 are operated with the DCLS configuration in the fourth execution cycle 4C at time t1, t2, t3 and t4, and schedules the operations of the HWAs 3 and 4 in each execution cycle. Alternatively, the DCLS controller 5 may determine that at time t1, the HWAs 3 and 4 are operated with the DCLS configuration in any of the first execution cycle 1C, second execution cycle 2C and third execution cycle 3C, and perform scheduling, and after time t1, the HWAs 3 and 4 may be operated with the DCLS configuration in the determined execution cycle.

Furthermore, the DCLS controller 5 can determine that the operation with the DCLS configuration is not finished even though the remaining time period tr becomes zero, on the basis of presence or absence of the output Output0 of the HWA 3 and the output Output1 of the HWA4. Thus, the DCLS controller 5 operates the HWAs 3 and 4 with the DCLS configuration in the execution cycle (the fourth execution cycle 4C in the example described above) determined by the scheduler 5c. However, if at least one of the HWAs 3 and 4 does not finish the operation with the DCLS configuration even though the remaining time period tr is zero, the DCLS controller 5 outputs the alarm signal ALARM to the ECU 100. The DCLS controller 5 holds a state flag indicating that a failure cannot be detected, in a predetermined register among the registers 5d.

When the ECU 100 receives the alarm signal ALARM, the ECU 100 executes a predetermined process. The ECU 100 can obtain cause information on the output of the alarm signal ALARM, by referring to each register among the registers 5d.

In the embodiment described above, the hardware acceleration unit 2 includes the two HWAs 3 and 4. Alternatively the number of HWAs may be four or more (an even number, such as 4, 6, 8, . . . ).

For example, in a case of four or more HWAs, the DCLS controller 5 determines the timing at which operation with the DCLS configuration is achieved with respect to every pair of HWAs.

As described above, the DCLS controller 5 determines the timing at which the HWAs 3 and 4 are operated with the DCLS configuration in the FDTI, by the scheduler 5c. The HWAs 3 and 4 are operated with the DCLS configuration at the determined DCLS configuration execution timing. Accordingly, in case the HWAs 3 and 4 have a fault, the DCLS controller 5 can output the alarm signal ALARM to the ECU 100 in the FDTI.

The scheduler 5c of the DCLS controller 5 determines the timing at which the HWAs 3 and 4 are operated with the DCLS configuration, from the value of the FDTI register 5a, and information on the timer 5b, that is, performs scheduling.

At the timing when the HWAs 3 and 4 are operated with the DCLS configuration, the DCLS controller 5 operates the HWAs 3 and 4 with the DCLS configuration by outputting the switching signal DCLS_SWITCH to the selector 9, thus dynamically switching the DCLS configuration and a non-DCLS configuration.

The DCLS controller 5 operates the two HWAs 3 and 4 with the DCLS configuration in the determined one execution cycle in conformity with the FDTI cycle. While the two HWAs 3 and 4 are operated with the DCLS configuration, the two HWAs 3 and 4 execute the same process on the same input. Accordingly, only one function is executed.

However, in each execution cycle other than one execution cycle at which the HWAs 3 and 4 are operated with the DCLS configuration, the DCLS controller 5 releases the DCLS configuration of the HWAs 3 and 4 and allows the two HWAs 3 and 4 to execute two processes. While the DCLS configuration of the HWAs 3 and 4 is released, the two HWAs 3 and 4 can execute processes on inputs different from each other, and execute processes different from each other, thus allowing two functions to be executed.

The DCLS controller 5 can integrate the outputs of various alarm signals DCLS_ALARM and CMP_LF_ALARM. Even if the comparators 6 and 7 output the alarm signal, the mask process described above is performed, thereby allowing the DCLS controller 5 not to output the alarm signal ALARM to the ECU 100 while the two HWAs 3 and 4 are operated with the non-DCLS configuration.

As described above, according to the embodiment described above, even if the circuit scale of the functional block is large, a semiconductor device can be provided that can detect a fault in a predetermined period after occurrence of the fault while avoiding increase in the circuit scale due to simple DCLS achievement.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalents are intended to cover such forms or modifications as would fall within the scope and spirit of the inventions.

What is claimed is:

1. A semiconductor device, comprising:
a first hardware accelerator and a second hardware accelerator; and
a controller configured to operate the first and second hardware accelerators so as to perform a first function and a second function of the respective hardware accelerators in each execution cycle among a plurality of execution cycles, and determine a timing of an execution cycle in which the first and second hardware accelerators are operated with a dual-core lock-step configuration among the execution cycles included in a predetermined period.

2. The semiconductor device according to claim 1, wherein
the controller includes: a register configured to store the predetermined period; and a remaining time period output circuit configured to output a remaining time period in the predetermined period, and
the controller determines the timing of the execution cycle in which the first and second hardware accelerators are operated with the dual-core lock-step configuration, based on the predetermined period stored in the register and on the remaining time period output from the remaining time period output circuit.

3. The semiconductor device according to claim 1, further comprising a selector configured to select a first input and a second input respectively input into the first and second hardware accelerators, wherein
the controller controls the selector such that an identical input is input into the first and second hardware accelerators, at the timing of the execution cycle in which the first and second hardware accelerators are operated with the dual-core lock-step configuration.

4. The semiconductor device according to claim 1, further comprising a first comparison circuit configured to compare a first output of the first hardware accelerator and a second output of the second hardware accelerator with each other, wherein
when the first and second hardware accelerators are in operation with the dual-core lock-step configuration, the controller outputs an alarm signal if the first output and the second output do not coincide with each other as a result of comparison by the first comparison circuit.

5. The semiconductor device according to claim 4, further comprising a second comparison circuit configured to compare the first output of the first hardware accelerator and the second output of the second hardware accelerator with each other, wherein
if a first comparison result of the first comparison circuit and a second comparison result of the second comparison circuit do not coincide with each other, the controller outputs the alarm signal.

6. The semiconductor device according to claim 5, wherein only when the first and second hardware accelerators are in operation with the dual-core lock-step configuration, the first comparison circuit and the second comparison circuit output to the controller, the first comparison result by the first comparison circuit and the second comparison result by the second comparison circuit.

7. The semiconductor device according to claim 5, wherein only when the first and second hardware accelerators are in operation with the dual-core lock-step configuration, the controller outputs the alarm signal, based on the first comparison result by the first comparison circuit and the second comparison result by the second comparison circuit.

8. The semiconductor device according to claim 1, wherein the first function and the second function are performed by processes on a first frame image and a second frame image respectively input into the first and second hardware accelerators at every execution cycle.

9. The semiconductor device according to claim 8, wherein the first function and the second function are object recognition for the first frame image and the second frame image.

10. The semiconductor device according to claim 8, wherein the semiconductor device is a semiconductor device mounted on an automobile.

11. The semiconductor device according to claim 1, wherein the predetermined period is a set period from occurrence of a fault in the semiconductor device to detection of the fault.

12. The semiconductor device according to claim 1, further comprising a first memory and a second memory that are volatile memories each having a function of correcting an error of data, and are respectively used by the first and second hardware accelerators to write and read the data, wherein
an identical data is input into the first memory and the second memory, at the timing of the execution cycle in which the first and second hardware accelerators are operated with the dual-core lock-step configuration.

13. The semiconductor device according to claim 1, wherein the controller determines the timing of the execution cycle in which the first and second hardware accelerators are operated with the dual-core lock-step configuration, based on a maximum processing time period of the first and second hardware accelerators.

14. The semiconductor device according to claim 13, wherein the maximum processing time period is a previously measured value in a first processing time period of the first hardware accelerator and a second processing time period of the second hardware accelerator, or a time period estimated from the measured value.
